(19) United States
(12) Patent Application Publication
(10) Pub. No.: US 2026/0218736 A1
(43) Pub. Date: Jul. 30, 2026

(54) QUICK-RELEASE CLAMPING MECHANISM

(71) Applicant: Indian Motorcycle International, LLC, Medina, MN (US)

(72) Inventors: Michael Keller, Seewil 3256 (CH); Matthias Botta, Brugg CH-2555 (CH); Arif Keskin, Lommiswil 4514 (CH); Joseph W. Klein, Stillwater, MN (US); Clark D. Davis, Shoreview, MN (US); Steven F. Kruger, Forest Lake, MN (US)

(21) Appl. No.: 19/146,699

(22) PCT Filed: Jan. 9, 2024
(86) PCT No.: PCT/US2024/010825

§ 371 Date: Jul. 9, 2025

Related U.S. Application Data
(60) Provisional application No. 63/437,876, filed on Jan. 9, 2023.

(51) Int. Cl. F16B 2/10; B62J 17/04

(52) U.S. Cl. CPC F16B 2/10; B62J 17/04

(57) ABSTRACT

A clamping mechanism includes a curved latch having a resilient pad, a mount knuckle, and a slot, a clamp having a resilient pad, an inner knuckle pivotally connected to the mount knuckle by a first pivot pin, and an outer knuckle, a lever having a fulcrum knuckle pivotally connected to the outer knuckle by a second pivot pin, and a follower knuckle between the fulcrum knuckle and an outer edge of the lever, and a hook including a hook knuckle pivotally connected to the follower knuckle by a third pivot pin, and a catch having a curved end wall. The mechanism is movable to clamp to a cylindrical object by engaging the curved end wall with the slot and rotating the lever about the second pivot pin toward the clamp, drawing the third pivot pin and the hook knuckle toward the clamp and compressing the resilient pads against the object.

### TECHNICAL FIELD

The present application claims the benefit of U.S. Provisional Patent Application No. 63/437,876, filed Jan. 9, 2023, titled QUICK-RELEASE CLAMPING MECHANISM, the entire disclosure of which is expressly incorporated by reference herein

### TECHNICAL FIELD

The present disclosure relates to a clamping mechanism, and in particular a quick-release clamping mechanism configured to connect to cylindrical objects such as the fork tubes of a motorcycle.

### BACKGROUND

Many objects are removably clamped to other supporting objects using one or more clamping mechanisms instead of being permanently attached or removably attached using bolts, screws, or other hardware. Many such clamping mechanisms require the use of tools such as a wrench or a screwdriver to apply the clamping force to the supporting object. Other clamping mechanisms require the use of two hands to apply the clamping force, one hand to hold the clamping mechanism in place, and another hand to operate the clamping mechanism such as by rotating a handle to tighten the clamping mechanism onto the supporting object. Additional challenges arise when the supporting object is cylindrical in shape. Accordingly, it is desirable to provide a clamping mechanism that permits quick, easy removable attachment of an object to a cylindrical supporting object without the need of tools or two hands.

### SUMMARY

In one embodiment of the present disclosure, a clamping mechanism is provided, comprising: a mount including a curved latch having an inner concave surface with a resilient pad, a mount knuckle, and a slot; a clamp including upper and lower clamping segments, each having an inner concave surface with a resilient pad, an inner knuckle pivotally connected to the mount knuckle by a first pivot pin, and an outer knuckle; a lever including upper and lower arms, each having a fulcrum knuckle pivotally connected to the outer knuckles of the clamp by a second pivot pin, and a follower knuckle positioned between the fulcrum knuckle and an outer edge of the lever; and a hook including a hook knuckle pivotally connected to the follower knuckles of the lever by a third pivot pin, and a catch having a curved end wall; wherein the clamping mechanism is movable to an engaged state around a cylindrical object by rotating the clamp, the lever and the hook relative to one another about the first, second and third pivot pins and engaging the curved end wall of the hook with the slot of the curved latch; and wherein the clamping mechanism is movable from the engaged state to a fully clamped state secured to the cylindrical object by rotating the outer edge of the lever about the second pivot pin toward the clamp, thereby drawing the third pivot pin and the hook knuckle toward the clamp and compressing the resilient pads of the curved latch and the clamp against the cylindrical object. In one aspect of this embodiment, the mount further includes a pair of arms extending from the curved latch, each arm including a mating surface configured to engage an object to be clamped to the cylindrical object and a threaded boss configured to receive a bolt to attach the object to the arm. In another aspect, the curved latch further includes an outer convex surface with a protruding ridge that extends along the slot, the protruding ridge being configured to mate with an inner concave surface of the curved end wall of the catch when the clamping mechanism is in the fully clamped state. In a variant of this aspect, the curved latch further includes a threaded boss disposed on the outer convex surface adjacent the slot, the threaded boss being configured to receive a bolt that prevents removal of the curved end wall of the hook from the slot of the curved latch. In another aspect, the upper and lower clamping segments of the clamp are connected to one another by a connecting portion having an outer edge that, together with the upper and lower clamping segments forms a first cutout that receives the lever when the clamping mechanism is in the fully clamped state. In a variant of this aspect, the connecting portion further includes an inner edge that, together with inner knuckles of the upper and lower clamping segments forms a second cutout that receives the mount knuckle. In another aspect of this embodiment, the lever includes a force body including the outer edge, and a stop formed on an inner surface of the force body, the upper and lower arms of the lever extending from force body. In yet another aspect, the first pivot pin extends through cylindrical bores formed through the inner knuckles of the clamp and the mount knuckle, the second pivot pin extends through cylindrical bores formed through the outer knuckles of the clamp and the fulcrum knuckles of the lever, and the third pivot pin extends through cylindrical bores formed through the follower knuckles of the lever and the hook knuckle. In a variant of this aspect, at least one inner knuckle of the clamp includes an annular slot that extends through a portion of the at least one inner knuckle into the cylindrical bore formed through the at least one inner knuckle, the annular slot being configured to receive an E-clip that engages a groove formed in the first pivot pin to retain the first pivot pin in the at least one inner knuckle. In another variant, the first pivot pin extends through a first O-ring positioned between the inner knuckle of the upper clamping segment of the clamp and the fulcrum knuckle of the upper arm of the lever, and a second O-ring positioned between the fulcrum knuckle of the lower arm of the lever and the inner knuckle of the lower clamping segment of the clamp. In still another variant, at least one outer knuckle of the clamp includes an annular slot that extends through a portion of the at least one outer knuckle into the cylindrical bore formed through the at least one outer knuckle, the annular slot being configured to receive an E-clip that engages a groove formed in the second pivot pin to retain the second pivot pin in the at least one outer knuckle. In a further variant, the second pivot pin extends through a first O-ring positioned between the outer knuckle of the upper clamping segment of the clamp and the follower knuckle of the upper arm of the lever, and a second O-ring positioned between the follower knuckle of the lower arm of the lever and the outer knuckle of the lower clamping segment of the clamp. In another variant of this aspect, the hook knuckle includes an annular slot that extends through a portion of the hook knuckle into the cylindrical bore formed through the hook knuckle, the annular slot being configured to receive an E-clip that engages a groove formed in the third pivot pin to retain the third pivot pin in the hook knuckle. In still another variant, the third pivot pin extends through a first O-ring positioned between the follower knuckle of the upper arm of the lever and the hook knuckle, and a second O-ring positioned between the hook knuckle and the follower knuckle of the lower arm of the lever. In another aspect of this embodiment, a force required to rotate the outer edge of the lever about the second pivot pin toward the clamp increases as the lever is moved from a first position when the clamping mechanism is in the engaged state to a second position wherein the second pivot pin, the third pivot pin and a contact line between the curved end wall of the hook and the slot are aligned. In a variant of this aspect, the lever is in the second position, a maximum compression force is applied to the cylindrical object by the resilient pads of the curved latch and the upper and lower clamping segments. In another variant, the force required to rotate the outer edge of the lever about the pivot pin toward the clamp is negative as the lever is rotated past the second position to a third position wherein a stop formed on the lever engages the cylindrical object. In a variant of this variant, a compression force applied to the cylindrical object by the resilient pads of the curved latch and the upper and lower clamping segments decreases as the lever is rotated from the second position to the third position. In a further variant, the third position of the lever corresponds to the fully clamped state of the clamping mechanism.

According to another embodiment of the present disclosure, a clamping system for removably securing a windshield to fork tubes of a motorcycle is provided, comprising: a left-hand clamping mechanism configured to clamp to a left-hand fork tube; and a right-hand clamping mechanism configured to clamp to a right-hand fork tube; wherein each of the left-hand clamping mechanism and the right-hand clamping mechanism comprises: a mount including a curved latch having an inner concave surface with a resilient pad, a mount knuckle, and a slot; a clamp including upper and lower clamping segments, each having an inner concave surface with a resilient pad, an inner knuckle pivotally connected to the mount knuckle by a first pivot pin, and an outer knuckle; a lever including upper and lower arms, each having a fulcrum knuckle pivotally connected to the outer knuckles of the clamp by a second pivot pin, and a follower knuckle positioned between the fulcrum knuckle and an outer edge of the lever; and a hook including a hook knuckle pivotally connected to the follower knuckles of the lever by a third pivot pin, and a catch having a curved end wall; wherein the mount of the left-hand clamping mechanism includes a pair of arms extending from the curved latch, each arm including a mating surface configured to engage a left-hand side of the windshield and a threaded boss configured to receive a bolt to attach the arms to the left-hand side of the windshield; wherein the mount of the right-hand clamping mechanism includes a pair of arms extending from the curved latch, each arm including a mating surface configured to engage a right-hand side of the windshield and a threaded boss configured to receive a bolt to attach the arms to the right-hand side of the windshield; wherein each of the left-hand clamping mechanism and the right-hand clamping mechanism is movable to an engaged state around the corresponding fork tube by rotating the clamp, the lever and the hook relative to one another about the first, second and third pivot pins and engaging the curved end wall of the hook with the slot of the curved latch; and wherein each of the left-hand clamping mechanism and the right-hand clamping mechanism is movable from the engaged state to a fully clamped state secured to the corresponding fork tube by rotating the outer edge of the lever about the second pivot pin toward the clamp, thereby drawing the third pivot pin and the hook knuckle toward the clamp and compressing the resilient pads of the curved latch and the clamp against the corresponding fork tube. In one aspect of this embodiment, the curved latch of each of the left-hand clamping mechanism and the right-hand clamping mechanism further includes an outer convex surface with a protruding ridge that extends along the slot, the protruding ridge being configured to mate with an inner concave surface of the curved end wall of the catch when the clamping mechanisms are in the fully clamped state. In a variant of this aspect, the curved latch of each of the left-hand clamping mechanism and the right-hand clamping mechanism further includes a threaded boss disposed on the outer convex surface adjacent the slot, the threaded boss being configured to receive a bolt that prevents removal of the curved end wall of the hook from the slot of the curved latch. In another aspect of this embodiment, the upper and lower clamping segments of the clamp of each of the left-hand clamping mechanism and the right-hand clamping mechanism are connected to one another by a connecting portion having an outer edge that, together with the upper and lower clamping segments forms a first cutout that receives the lever when the clamping mechanisms are in the fully clamped state. In a variant of this aspect, the connecting portion of each of the left-hand clamping mechanism and the right-hand clamping mechanism further includes an inner edge that, together with inner knuckles of the upper and lower clamping segments forms a second cutout that receives the mount knuckle of the clamping mechanism. In yet another aspect, the lever of each of the left-hand clamping mechanism and the right-hand clamping mechanism includes a force body including the outer edge, and a stop formed on an inner surface of the force body, the upper and lower arms of the lever extending from force body. In another aspect, the first pivot pin of each of the left-hand clamping mechanism and the right-hand clamping mechanism extends through cylindrical bores formed through the inner knuckles of the clamp and the mount knuckle, the second pivot pin of each of the left-hand clamping mechanism and the right-hand clamping mechanism extends through cylindrical bores formed through the outer knuckles of the clamp and the fulcrum knuckles of the lever, and the third pivot pin of each of the left-hand clamping mechanism and the right-hand clamping mechanism extends through cylindrical bores formed through the follower knuckles of the lever and the hook knuckle. In a variant of this aspect, the first pivot pin of each of the left-hand clamping mechanism and the right-hand clamping mechanism extends through a first O-ring positioned between the inner knuckle of the upper clamping segment of the clamp and the fulcrum knuckle of the upper arm of the lever, and a second O-ring positioned between the fulcrum knuckle of the lower arm of the lever and the inner knuckle of the lower clamping segment of the clamp. In a further variant, the second pivot pin of each of the left-hand clamping mechanism and the right-hand clamping mechanism extends through a first O-ring positioned between the outer knuckle of the upper clamping segment of the clamp and the follower knuckle of the upper arm of the lever, and a second O-ring positioned between the follower knuckle of the lower arm of the lever and the outer knuckle of the lower clamping segment of the clamp. In still a further variant, the third pivot pin of each of the left-hand clamping mechanism and the right-hand clamping mechanism extends through a first O-ring positioned between the follower knuckle of the upper arm of the lever and the hook knuckle, and a second O-ring positioned between the hook knuckle and the follower knuckle of the lower arm of the lever. In another aspect of this embodiment, the left-hand clamping mechanism is a mirror image of the right-hand clamping mechanism. In another aspect, the left-hand clamping mechanism is moved from the engaged state to the fully clamped state by rotating the outer edge of the lever about the second pivot pin in a clockwise direction and the right-hand clamping mechanism is moved from the engaged state to the fully clamped state by rotating the outer edge of the lever about the second pin in a counter-clockwise direction. In another aspect, when the clamping mechanisms are attached to the windshield, a distance between the outer edge of the lever of the left-hand clamping mechanism and the outer edge of the lever of the right-hand clamping mechanism is greater than a smallest distance between the fork tubes. In a variant of this aspect, as the left-hand clamping mechanism and the right-hand clamping mechanism are pushed onto the left-hand fork tube and the right-hand fork tube, respectively, the windshield flexes to permit the outer edges of the levers of the clamping mechanisms to move toward one another.

In another embodiment of the present disclosure, a method of securing a removable windshield to fork tubes of a motorcycle is provided, comprising: attaching a left-hand clamping mechanism to a left-hand side of the windshield; attaching a right-hand clamping mechanism to a right-hand side of the windshield; pushing the left-hand clamping mechanism onto a left fork tube such that a resilient pad affixed to a curved latch of the left-hand clamping mechanism engages one side of the left fork tube; pushing the right-hand clamping mechanism onto a right fork tube such that a resilient pad affixed to a curved latch of the right-hand clamping mechanism engages one side of the right fork tube that faces the one side of the left-fork tube; rotating a clamp, a lever and a hook of the left-hand clamping mechanism counter-clockwise around the left fork tube to engage a curved end wall of the hook with a slot formed through the curved latch of the left-hand clamping mechanism; rotating a clamp, a lever and a hook of the right-hand clamping mechanism clockwise around the right fork tube to engage a curved end wall of the hook with a slot formed through the curved latch of the right-hand clamping mechanism; rotating the lever of the left-hand clamping mechanism clockwise about a pivot pin toward the clamp, thereby drawing an end of the hook toward the clamp and compressing the resilient pad of the curved latch and a resilient pad affixed to the clamp against the left fork tube; and rotating the lever of the right-hand clamping mechanism counter-clockwise about a pivot pin toward the clamp, thereby drawing an end of the hook toward the clamp and compressing the resilient pad of the curved latch and a resilient pad affixed to the clamp against the right fork tube.

### BRIEF DESCRIPTION OF THE DRAWINGS

FIG. 1 is a side view of a motorcycle with a windshield attached to the fork tubes using clamping mechanisms according to the present disclosure;

FIG. 2 is a perspective view of one embodiment of a clamping mechanism according to the present disclosure;

FIG. 3 is an exploded perspective view of the clamping mechanism of FIG. 2;

FIG. 4 is a perspective view of a pair of clamping mechanisms of FIG. 2 attached to a windshield;

FIG. 5A is a perspective view of one side of a mount of the clamping mechanism of FIG. 2;

FIG. 5B is a perspective view of another side of the mount of FIG. 5A;

FIG. 6A is a perspective view of one side of a clamp of the clamping mechanism of FIG. 2;

FIG. 6B is a perspective view of another side of the clamp of FIG. 6A;

FIG. 7A is a perspective view of one side of a lever of the clamping mechanism of FIG. 2;

FIG. 7B is a perspective view of another side of the lever of FIG. 7A;

FIG. 8A is a perspective view of one side of a hook of the clamping mechanism of FIG. 2;

FIG. 8B is a perspective view of another side of the hook of FIG. 8A;

FIG. 9 is a perspective view of portions of the clamping mechanism of FIG. 2 depicting resilient pads positioned to contact a fork tube when the clamping mechanism is in a fully clamped state;

FIG. 10 is a perspective view of a clamping mechanism according to one embodiment of the present disclosure in a fully clamped state onto a fork tube and supporting a windshield;

FIG. 11 is a top plan view of the clamping mechanism and the fork tube of FIG. 10 taken along line A-A of FIG. 10;

FIGS. 12-14 are top plan views depicting the operation of attaching a windshield and a pair of clamping mechanisms of the present disclosure to a pair of fork tubes;

FIG. 15 is a top plan view of a clamping mechanism according to the present disclosure showing forces relating to operation of the clamping mechanism; and

FIG. 16 provides a top plan view of a clamping mechanism of the present disclosure in various states of clamping onto a fork tube and a corresponding force graph.

### DETAILED DESCRIPTION

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples,” “coupled,” “coupler,” and variations thereof are used to include both arrangements wherein two or more components are in direct physical contact and arrangements wherein the two or more components are not in direct contact with each other (e.g., the components are “coupled” via at least a third component, but still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

The clamping mechanisms described herein generally include four components, including a mount that engages the cylindrical object and includes a slot, a clamp that is movable relative to the mount to engage and substantially enclose the cylindrical object, a lever that pivots relative to the clamp, and a hook that is pivotally coupled to the lever and removably engaged with the slot. When the mount and the clamp substantially enclose the cylindrical object and the hook is engaged with the slot, the lever can be pivoted toward the clamp, thereby drawing the hook toward the clamp. Resilient pads affixed to internal surfaces of the mount and the clamp apply compression force to the cylindrical object when the lever is pivoted into contact with the cylindrical object.

While the description below provides an example of a clamping mechanism according to the present disclosure wherein the clamping mechanism connects a removable windshield to a pair of fork tubes of a motorcycle, it should be understood that any of a variety of different objects may be removably coupled to one another according to the teachings of the present disclosure. Stated another way, the mount component described below may be configured to connect to any of a variety of objects other than a windshield, and the clamp, lever and hook components described below may be configured to clamp to any of a variety of cylindrical objects other than the fork tubes of a motorcycle. The present disclosure is not intended to be limited by the example applications described herein.

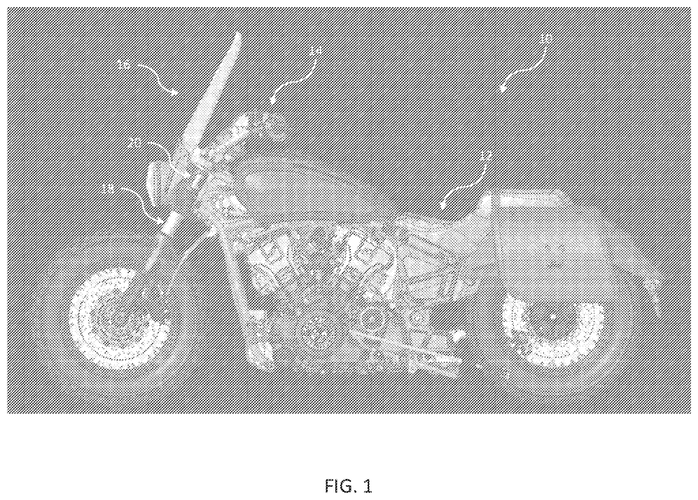

FIG. 1 depicts a motorcycle 10 having, among other things, a seat 12, a set of handlebars 14, a removable windshield 16, which is connected to a pair of fork tubes 18 connected to the handlebars 14 (only one fork tube 18 shown) of the motorcycle 10 by a pair of clamping mechanisms 20 (only one clamping mechanism 20 shown). Generally, the windshield 16 may be coupled to the fork tubes 18 by the clamping mechanisms 20 to shield a rider sitting on the seat 12 and holding the handlebars 14 from wind, rain, insects, road debris, etc., or removed from the fork tubes 18 for a different look and riding experience, depending upon the riding conditions and the preferences of the rider. As indicated above, it is desirable to be able to quickly and easily remove the windshield 16 from the motorcycle 10, and to quickly, easily and securely couple the windshield 16 to the motorcycle 10 as desired by the rider. The clamping mechanism 20 described below provides that ability and other features to improve the use of removable windshields.

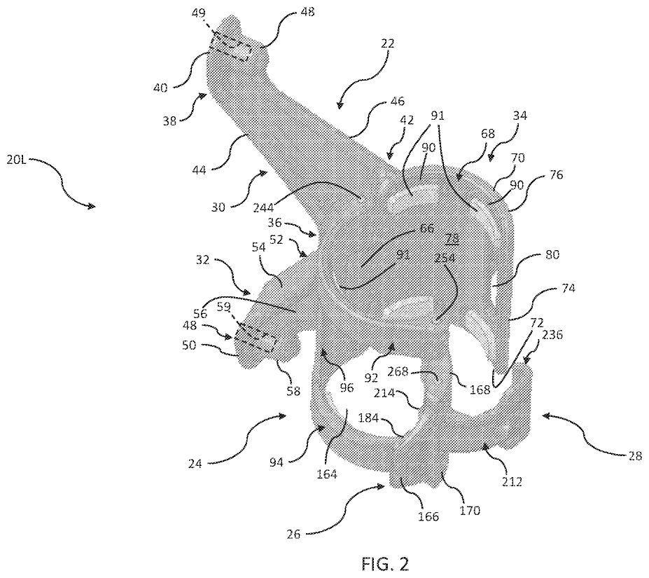

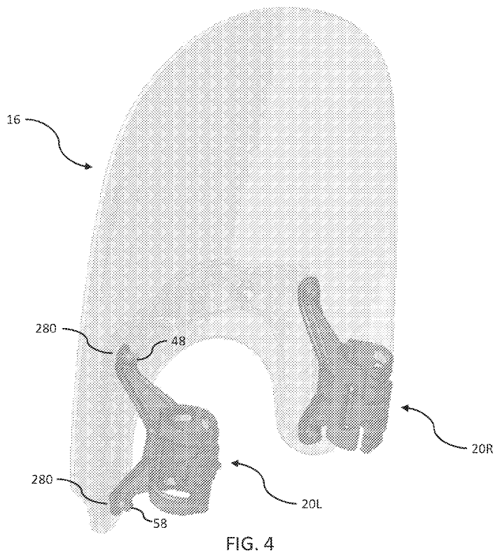

Referring now to FIG. 2, a quick-release clamping mechanism 20 according to one embodiment of the present disclosure is shown. In the example shown, the clamping mechanism 20 is configured for coupling to a left fork tube 18 (as viewed from the seat 12) and is referred to hereinafter as a “clamping mechanism 20L or a left-hand clamping mechanism 20L.” As shown in FIG. 4, a pair of clamping mechanisms 20 are used to couple a windshield 16 to a pair of fork tubes 18, including a clamping mechanism 20 configured for coupling to a right fork tube 18 (as viewed from the seat 12) and hereinafter referred to as a “clamping mechanism 20R or a right-hand clamping mechanism 20R.” As should be apparent from the figures, the left-hand clamping mechanism 20L is a mirror image of the right-hand clamping mechanism 20R.

Still referring to FIG. 2, clamping mechanism 20L generally includes a mount 22, a clamp 24, a lever 26 and a hook 28. The mount 22 includes a pair of arms 30, 32 extending from a curved latch 34. Each of the arms 30, 32 also extends from a central body 36, which extends from the curved latch 34. As is further described below, the arm 30 connects to an upper location of the windshield (as viewed from the seat 12) and is hereinafter referred to as the “upper arm 30.” Similarly, since the arm 32 connects to a lower location of the windshield relative to the upper location (as viewed from the seat 12), the arm 32 is hereinafter referred to as the “lower arm 32.” The upper arm 30 includes a distal end 38 having an outer mating surface 40 which engages a surface of the windshield 16 as described below, and a proximal end 42 adjacent the curved latch 34 and the central body 36. A strut 44 extends along the upper arm 30 between the distal end 38 and the proximal end 42. The upper arm 30 further includes a rib 46 extending substantially perpendicularly from the strut 44 between the distal end 38 and the proximal end 42 to strengthen the upper arm 30. The rib 46 terminates at a threaded boss 48 at the distal end 38 adjacent the mating surface 40. The threaded boss 48 includes a threaded bore 49 (shown in dashed lines) that extends into the threaded boss 48 from the mating surface 40.

Similarly, the lower arm 32 includes a distal end 48 having an outer mating surface 50 which engages a surface of the windshield 16 as described below, and a proximal end 52 adjacent the curved latch 34 and the central body 36. A strut 54 extends along the lower arm 32 between the distal end 48 to the proximal end 52. The lower arm 32 further includes a rib 56 extending substantially perpendicularly from the strut 54 between the distal end 48 and the proximal end 52 to strengthen the lower arm 32. The rib 56 terminates at a threaded boss 58 at the distal end 48 adjacent the mating surface 50. The threaded boss 58 includes a threaded bore 59 (shown in dashed lines) that extends into the threaded boss 58 from the mating surface 50.

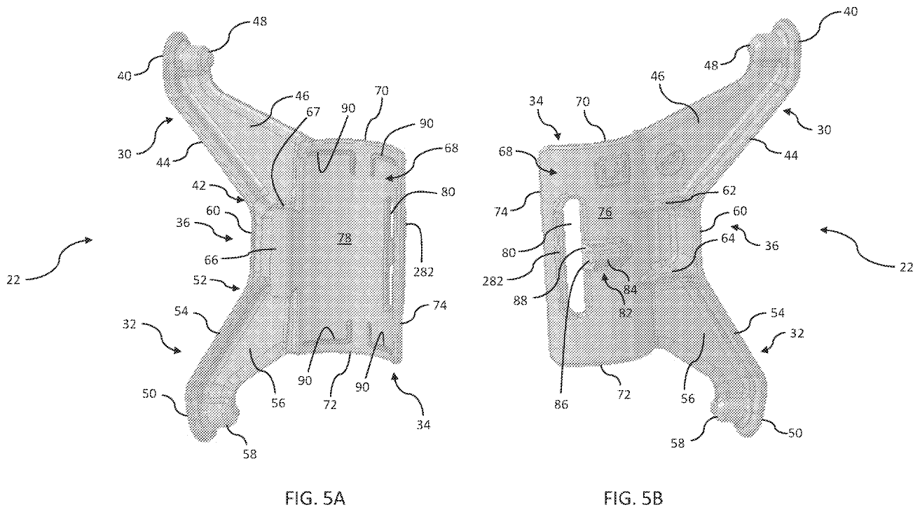

As best shown in FIG. 5B, the central body 36 of the mount 22 includes a connecting strut 60 that extends between the strut 44 of the upper arm 30 and the strut 54 of the lower arm 32. Additionally, the central body 36 includes an upper rib 62 extending between the strut 44, the connecting strut 60 and the curved latch 34, and a lower rib 64 extending between the strut 54, the connecting strut 60 and the curved latch 34. As shown in FIG. 5A, the central body 36 further includes a mount knuckle 66 extending between the proximal end 42 of the upper arm 30 and the proximal end 52 of the lower arm 32. A cylindrical bore 67 extends through the mount knuckle 66 to receive a pivot pin as is further described below.

It should be understood that the configuration of the mount 22 as thus far described may be modified to accommodate connection to any of a variety of different objects that are intended to be quickly and easily attached to and detached from a cylindrical object. More or fewer arms 30, 32 may be used and different configurations of the connection components may be used to permit connection to the object to be supported by the cylindrical object through use of the clamping mechanisms described herein.

Still referring to FIGS. 2, 5A and 5B, the curved latch 34 of the mount 22 includes a main body 68 having an upper edge 70, a lower edge 72, an outer edge 74, an outer convex surface 76 and an inner concave surface 78. The main body 68 is curved such that the inner concave surface 78 has a radius that is somewhat larger than a radius of the cylindrical object (i.e., the fork tube 18) to which the clamping mechanism 20L will be clamped. The main body 68 further includes a slot 80 that extends through the main body 68 adjacent the outer edge 74, and is elongated in a direction that is substantially parallel to the outer edge 74. As best shown in FIG. 11, a protruding ridge 282 extends outwardly from the outer convex surface 76 along an edge of the slot 80 adjacent the outer edge 74 of the main body 68. As is further described below, the protruding ridge 282 and the slot 80 are located and configured to receive a portion of the hook 28 to couple the hook 28 to the curved latch 34.

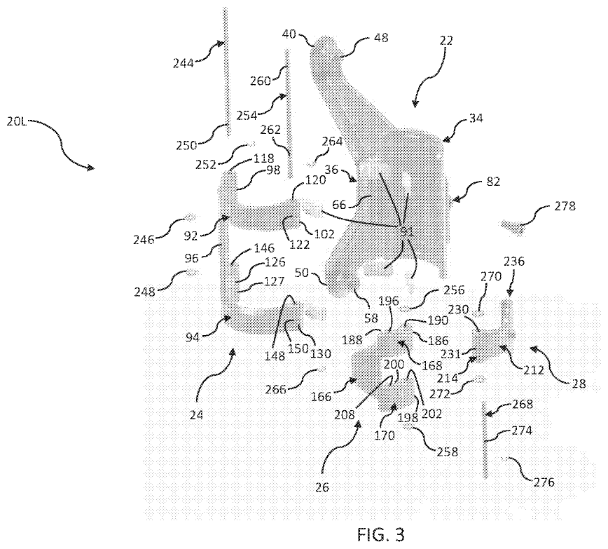

As best shown in FIG. 5B, a threaded boss 82 is formed on the outer convex surface 76 of the main body 68 and includes a body 84 and a threaded opening 86 that extends into the body 84 from an end 88 of the body 84 adjacent the slot 80. The threaded boss 82 receives a bolt 278 (FIG. 3) to prevent the hook 28 from being removed from the slot 80 as is further described below. Finally, the inner concave surface 78 of the main body 68 of the curved latch 34 includes a plurality of ridges 90 that protrude from the inner concave surface 78 and function primarily to the locate resilient pads 91 as is further described below.

Referring now to FIG. 2, 6A and 6B, the clamp 24 of the clamping mechanism 20L generally includes an upper clamping segment 92 and a lower clamping segment 94 connected together by a connecting segment 96. The upper clamping segment 92 includes an inner knuckle 98 at an inner end 100 and an outer knuckle 102 at an outer end 104, with a curved body 106 between the inner end 100 and the outer end 104. The curved body 106 includes an upper edge 108, a lower edge 110, an outer convex surface 112 and an inner concave surface 114 which has a radius that substantially matches the radius of the curved latch 34 of the mount 22. A ridge 116 is formed on and protrudes from the inner concave surface 114 adjacent the upper edge 108 of the curved body 106 and primarily functions to locate a resilient pad 91 as is further described below. The inner knuckle 98 of the upper clamping segment 92 includes a cylindrical bore 118 extending through the inner knuckle 98 to receive a pivot pin as is further described below.

Similarly, the outer knuckle 102 includes a cylindrical bore 120 extending through the outer knuckle 102 to receive a pivot pin as is further described below. The outer knuckle 102 further includes an annular slot 122 that extends through a portion of the outer knuckle 102 into the cylindrical bore 120 and lies in a plane that is substantially perpendicular to a longitudinal axis of the cylindrical bore 120. As is further described below, the annular slot 122 is configured to receive an E-clip that retains the pivot pin extending through the outer knuckle 102 within the cylindrical bore 120. The annular slot 122 intersects with a recess 124 formed into the outer knuckle 102 to provide easier access to the E-clip.

The lower clamping segment 94 also includes an inner knuckle 126 at an inner end 128 and an outer knuckle 130 at an outer end 132, with a curved body 134 between the inner end 128 and the outer end 132. The curved body 134 includes an upper edge 136, a lower edge 138, an outer convex surface 140 and an inner concave surface 142 which has a radius that substantially matches the radius of the upper clamping segment 92. A ridge 144 is formed on and protrudes from the inner concave surface 142 adjacent the lower edge 138 of the curved body 134 and primarily functions to locate a resilient pad 91 as is further described below. The inner knuckle 126 of the lower clamping segment 94 includes a cylindrical bore 146 extending through the inner knuckle 126 to receive a pivot pin as is further described below. The inner knuckle 126 also includes an annular slot 127 that extends through a portion of the inner knuckle 126 into the cylindrical bore 146 and lies in a plane that is substantially perpendicular to a longitudinal axis of the cylindrical bore 146. As is further described below, the annular slot 127 is configured to receive an E-clip that retains the pivot pin extending through the inner knuckle 126 within the cylindrical bore 146. The annular slot 127 intersects with a recess 129 formed into the inner knuckle 126 to provide easier access to the E-clip.

Similarly, the outer knuckle 130 includes a cylindrical bore 148 extending through the outer knuckle 130 to receive a pivot pin as is further described below. The outer knuckle 130 further includes an annular slot 150 that extends through a portion of the outer knuckle 130 into the cylindrical bore 148 and lies in a plane that is substantially perpendicular to a longitudinal axis of the cylindrical bore 148. As is further described below, the annular slot 150 is configured to receive an E-clip that retains the pivot pin extending through the outer knuckle 130 within the cylindrical bore 148. The annular slot 150 intersects with a recess 152 formed into the outer knuckle 130 to provide easier access to the E-clip.

The connecting portion 96 of the clamp 24 extends between the upper clamping segment 92 and the lower clamping segment 94 and includes an inner edge 154, an outer edge 156, an outer convex surface 158 and an inner concave surface 160. The inner concave surface 160 has a radius that substantially matches the radius of the inner concave surfaces 114, 142 of the upper clamping segment 92 and the lower clamping segment 94, respectively. As shown in the figures, the inner edge 154 of the connecting portion 96 is set back from an axis 155 extending through the cylindrical bore 118 of the inner knuckle 98 of the upper clamping segment 92 and the cylindrical bore 146 of the inner knuckle 126 of the lower clamping segment 94, thereby forming a cutout 162 that receives the mount knuckle 66 as described below. Similarly, the outer edge 156 is set back from an axis 157 extending through the cylindrical bore 120 of the outer knuckle 102 of the upper clamping segment 92 and the cylindrical bore 148 of the outer knuckle 130 of the lower clamping segment 94. Thus, the outer edge 156 of the connecting portion 96, the lower edge 110 of the upper clamping segment 92 and the upper edge 136 of the lower clamping segment 94 form a cutout 164 that receives the lever 26 when the clamping mechanism 20 is in a fully clamped state as described below.

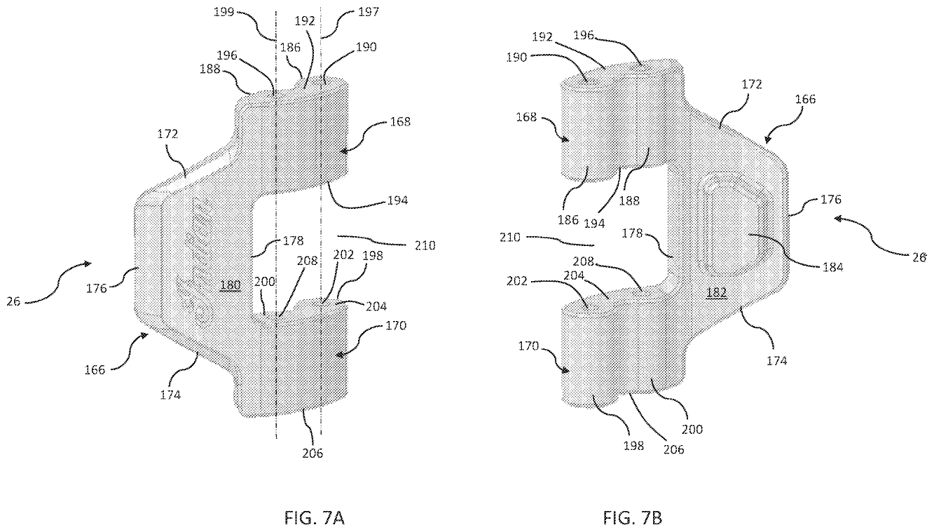

Referring now to FIGS. 2, 7A and 7B, the lever 26 of the clamping mechanism 20L generally includes a force body 166, an upper arm 168 and a lower arm 170, both extending from the force body 166. The force body 166 includes an upper edge 172, a lower edge 174, an outer edge 176 extending between the upper edge 172 and the lower edge 174, an inner edge 178, an outer surface 180 and an inner surface 182. A stop 184 is formed on the inner surface 182 in spaced-apart relationship to the upper edge 172, the lower edge 174 and the outer edge 176.

The upper arm 168 includes a fulcrum knuckle 186 and a follower knuckle 188. A cylindrical bore 190 extends through the fulcrum knuckle 186 from an upper surface 192 of the upper arm 168 to a lower surface 194 of the upper arm 168, and a cylindrical bore 196 extends through the follower knuckle 188 from the upper surface 192 to the lower surface 194 in parallel relationship with the cylindrical bore 190. Similarly, the lower arm 170 includes a fulcrum knuckle 198 and a follower knuckle 200. A cylindrical bore 202 extends through the fulcrum knuckle 198 from an upper surface 204 of the lower arm 170 to a lower surface 206 of the lower arm 170, and a cylindrical bore 208 extends through the follower knuckle 200 from the upper surface 204 to the lower surface 206 in parallel relationship with the cylindrical bore 202. In this manner, the cylindrical bore 190 through the fulcrum knuckle 186 of the upper arm 168 has an axis 197 that extends through the cylindrical bore 202 through the fulcrum knuckle 198 of the lower arm 170, and the cylindrical bore 196 through the follower knuckle 188 of the upper arm 168 has an axis 199 that extends through the cylindrical bore 208 through the follower knuckle 299 of the lower arm 170. As shown in the figures, the upper arm 168 is spaced apart from the lower arm 170 and, together with the inner edge 178 of the force body 166 form a cutout 210 which accommodates a portion of the hook 28 as is further described below.

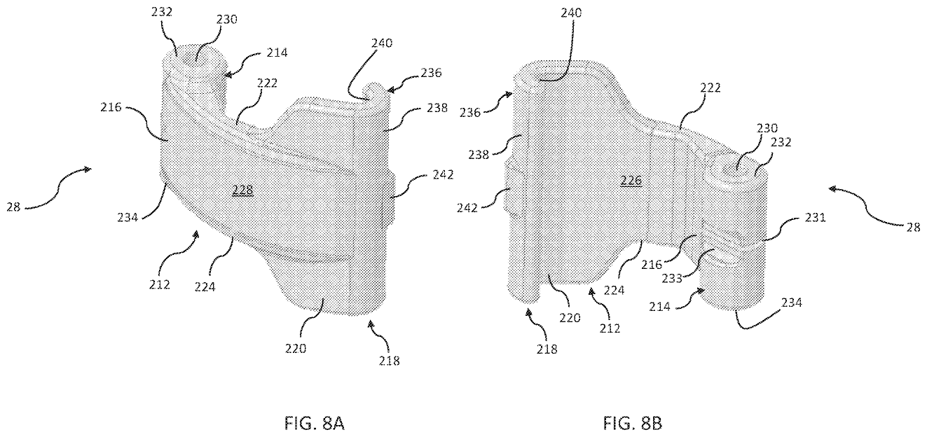

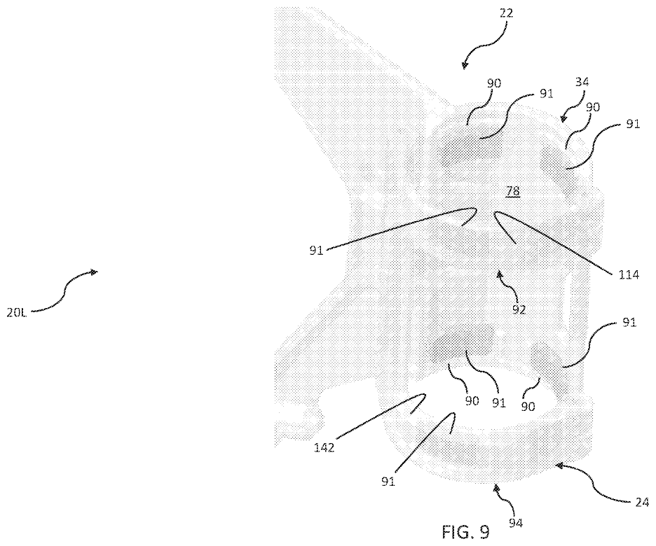

Referring now to FIGS. 2, 8A and 8B, the hook 28 of the clamping mechanism 20L generally includes a body 212, a hook knuckle 214 at an inner end 216 of the body 212, and a catch 218 at an outer end 220 of the body 212. The body 212 includes an upper edge 222, a lower edge 224, an inner surface 226 and an outer surface 228. A cylindrical bore 230 extends through the hook knuckle 214 between an upper surface 232 and a lower surface 234 of the hook knuckle 214. The hook knuckle 214 also includes an annular slot 231 that extends through a portion of the hook knuckle 214 into the cylindrical bore 230 and lies in a plane that is substantially perpendicular to a longitudinal axis of the cylindrical bore 230. The annular slot 231 intersects with a recess 233 formed into the hook knuckle 214 to provide easier access to and E-clip used to secure a pivot pin within the cylindrical bore 230 as is further described below. The catch 218 includes a curved end wall 236 with an outer convex surface 238 and an inner concave surface 240. A protrusion 242 extends from the outer convex surface 238 to cooperate with the bolt 278 (FIG. 3) received by the threaded boss 82 to prevent the hook 28 from being removed from the slot 80 of the main body 68 of the curved latch 34 as is further described below.

Referring now to FIG. 3, the remaining hardware of the clamping mechanism 20L is shown with the mount 22, the clamp 24, the lever 26 and the hook 28. As indicated by the figure, a first pivot pin 244 extends through the cylindrical bore 118 of the inner knuckle 98 of the upper clamping segment 92 of the clamp 24, through an O-ring 246 positioned between a lower surface of the inner knuckle 98 and an upper surface of the mount knuckle 66 of the central portion 36 of the mount 22, through the cylindrical bore 67 (FIG. 5A) of the mount knuckle 66 of the central portion 36, through another O-ring 248 positioned between a lower surface of the mount knuckle 66 of the central portion 36 and an upper surface of the inner knuckle 126 of the lower clamping segment 94 of the clamp 24, and through the cylindrical bore 146 of the inner knuckle 126 of the lower clamping segment 94. While O-rings are described herein, it should be understood that other components may be used to provide friction to the adjacent parts such as O-rings, wave washers, etc. The first pivot pin 244 includes an annular groove 250 at a location that aligns with the annular slot 127 of the inner knuckle 126 of the lower clamping segment 94 when the first pivot pin 244 is installed. An E-clip 252 is inserted though the annular slot 127 and into the annular groove 250 of the first pivot pin 244 to retain the first pivot pin 244 in place.

In an alternative embodiment, the connection between the clamp 24 and the mount 22 by the first pivot pin 244 may be replaced by a removable coupling between the clamp 24 and the mount 22. For example, the clamp 24 may include a hook that removably engages a slot formed in the mount 22. Alternatively, the mount 22 may include a hook that removably engages a slot formed in the clamp 24.

As further indicated by FIG. 3, a second pivot pin 254 extends through the cylindrical bore 120 of the outer knuckle 102 of the upper clamping segment 92 of the clamp 24, through a O-ring 256 positioned between a lower surface of the outer knuckle 102 of the upper clamping segment 92 and an upper surface of the fulcrum knuckle 186 of the upper arm 168 of the lever 26, through the cylindrical bore 190 of the fulcrum knuckle 186 of the upper arm 168, through the cylindrical bore 202 of the fulcrum knuckle 198 of the lower arm 170 of the lever 26, through another O-ring 258 positioned between a lower surface of the fulcrum knuckle 198 of the lower arm 170 of the lever 26 and an upper surface of the outer knuckle 130 of the lower clamping segment 94 of the clamp 24, and through the cylindrical bore 148 of the outer knuckle 130 of the lower clamping segment 94. The second pivot pin 254 includes an upper annular groove 260 at a location that aligns with the annular slot 122 of the outer knuckle 102 of the upper clamping segment 92 and a lower annular groove 262 at a location that aligns with the annular slot 150 of the outer knuckle 130 of the lower clamping segment 94 when the second pivot pin 254 is installed as described above. An E-clip 264 is inserted through the annular slot 122 of the outer knuckle 102 of the upper clamping segment 92 and into the upper annular groove 260 of the second pivot pin 254 to retain the second pivot pin 254 in place. An additional E-clip 266 is inserted through the annular slot 150 of the outer knuckle 130 of the lower clamping segment 94 and into the lower annular groove 262 of the second pivot pin 254 to further retain the second pivot pin 254 in place.

Finally, a third pivot pin 268 extends through the cylindrical bore 196 of the follower knuckle 188 of the upper arm 168 of the lever 26, through a O-ring 270 positioned between the lower surface 194 of the follower knuckle 188 and the upper surface 232 of the hook knuckle 214 of the hook 28, through the cylindrical bore 230 of the hook knuckle 214 of the hook 28, through another O-ring 272 positioned between the lower surface 234 of the hook knuckle 214 of the hook 28 and the upper surface 204 of the follower knuckle 200 of the lower arm 170 of the lever 26, and through the cylindrical bore 208 of the follower knuckle 200 of the lower arm 170. The third pivot pin 268 includes an annular groove 274 that aligns with the annular slot 231 of the hook knuckle 214 of the hook 28 when the third pivot pin 268 is installed as described above. An E-clip 276 is inserted through the annular slot 231 of the hook knuckle 214 of the hook 28 an into the annular groove 274 to retain the third pivot pin 268 in place.

The remaining components of the clamping mechanism 20L include the bolt 278 shown in FIG. 3 which is threaded into the threaded bore 82 of curved latch 34 to lock the hook 28 to the mount 22 as described below, and the bolts and washers (referred to herein as bolts 280 as shown in FIG. 4) which pass through the windshield 16 into the threaded bosses 48, 58 of the mount 22 to attach the windshield 16 to the clamping mechanism 20L.

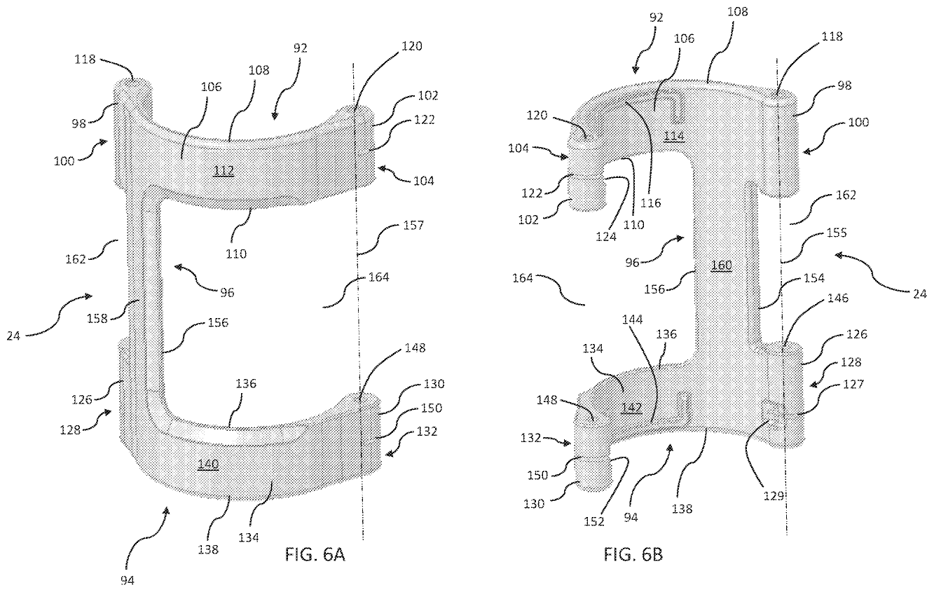

Referring now to FIG. 9, the clamping mechanism 20L is shown with the lever 26 and the hook 28 removed to better illustrate the placement of the six resilient pads 91. As shown, two upper resilient pads 91 are affixed to the inner concave surface 78 of the curved latch 34 of the mount 22 and an upper resilient pad 91 is affixed to the inner concave surface 114 of the upper clamping segment 92 of the clamp 24. The upper resilient pads 91 on the curved latch 34 are located by the ridges 90 and the upper resilient pad 91 on the upper clamping segment 92 is located by the ridge 116 (FIG. 6B). As shown, these three pads 91 are substantially coplanar and are spaced apart from one another about the substantially cylindrical area defined by the curved latch 34 and the upper clamping segment 92, thereby providing clamping force to the fork tube 18 from spaced apart angles for improved clamping force. In an alternative embodiment, the upper resilient pads 91 on the curved latch 34 are replaced by a single, elongated resilient pad 91 that spans substantially the entire inner concave surface 78.

Similarly, two lower resilient pads 91 are affixed to the inner concave surface 78 of the curved latch 34 of the mount 22 and a lower resilient pad 91 is affixed to the inner concave surface 142 of the lower clamping segment 94 of the clamp 24. The lower resilient pads 91 on the curved latch 34 are located by the ridges 90 and the lower resilient pad 91 on the lower clamping segment 92 is located by the ridge 144 (FIG. 6B). As shown, these three pads 91 are substantially coplanar and are spaced apart from one another about the substantially cylindrical area defined by the curved latch 34 and the lower clamping segment 94, thereby providing clamping force to the fork tube 18 from spaced apart angles for improved clamping force. In an alternative embodiment, the lower resilient pads 91 on the curved latch 34 are replaced by a single, elongated resilient pad 91 that spans substantially the entire inner concave surface 78.

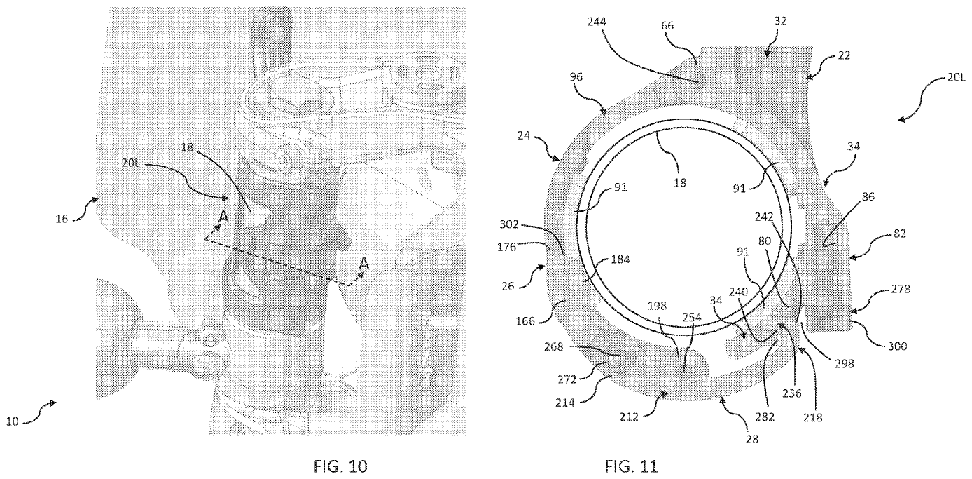

Referring now to FIGS. 10 and 11, the left-hand clamping mechanism 20L is shown attached to a windshield 16 and in a fully clamped state onto a fork tube 18 of the motorcycle 10. FIG. 11 is a cross-sectional view taken along the line A-A of FIG. 10. As shown, the lever 26 is fully closed such that the stop 184 of the force body 166 is in contact with the fork tube 18 and the curved end wall 236 of the catch 218 of the hook 28 is engaged within the slot 80 of the curved latch 34 such that the inner concave surface 240 of the catch 218 is engaged with the protruding ridge 282 that extends along the slot 80. When in this fully clamped state, the clamping mechanism 20L completely encloses the fork tube 18 and the resilient pads 91 are compressed against the fork tube 18 to securely attach the clamping mechanism 20L to the fork tube 18 as is further described below.

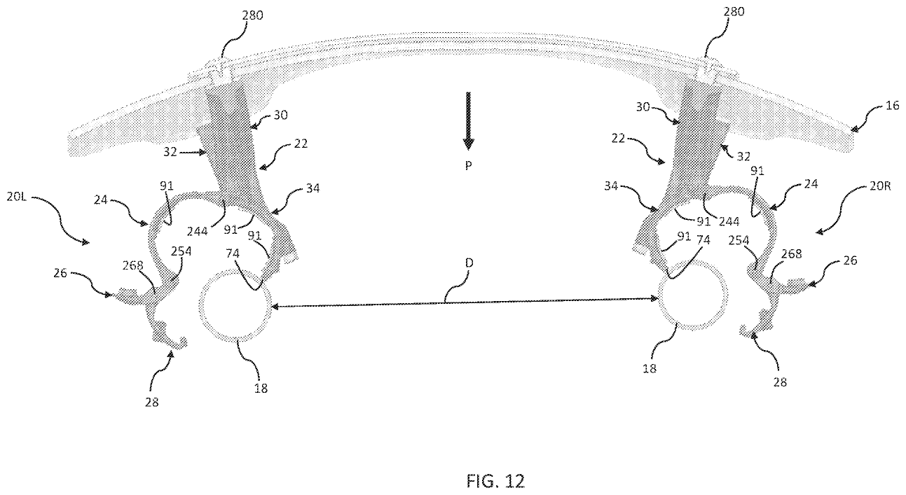

Referring now to FIGS. 12-14, the operation of coupling the windshield 16 to the fork tubes 18 begins by attaching the windshield 16 to the left-hand clamping mechanism 20L and the right-hand clamping mechanism 20R by passing the bolts 280 through the windshield 16 and threading them into the threaded bosses 48, 58 of the upper arms 30 and the lower arms 32, respectively, of the mounts 22 of the clamping mechanisms 20L, 20R as shown in FIG. 12. The mounting locations of the clamping mechanisms 20L, 20R are such that, once attached to the windshield 16, the distance between the outer edges 74 of the curved latches 34 of the mounts 22 is somewhat greater than the smallest distance D between the fork tubes 18. The clamping mechanisms 20L, 20R are placed onto the fork tubes 18 by pushing the windshield 16 in direction P (i.e., toward the fork tubes 18) to cause the windshield 16, which is made of a somewhat resilient material such as Plexiglas, to flex slightly as the outer edges 74 of the curved latches 34 pass over the fork tubes 18. As should be apparent from the foregoing, the curved latches 34 have an inner length that is less than 180 degrees to permit both curved latches 34 to substantially simultaneously engage the fork tubes 18 in the manner described above.

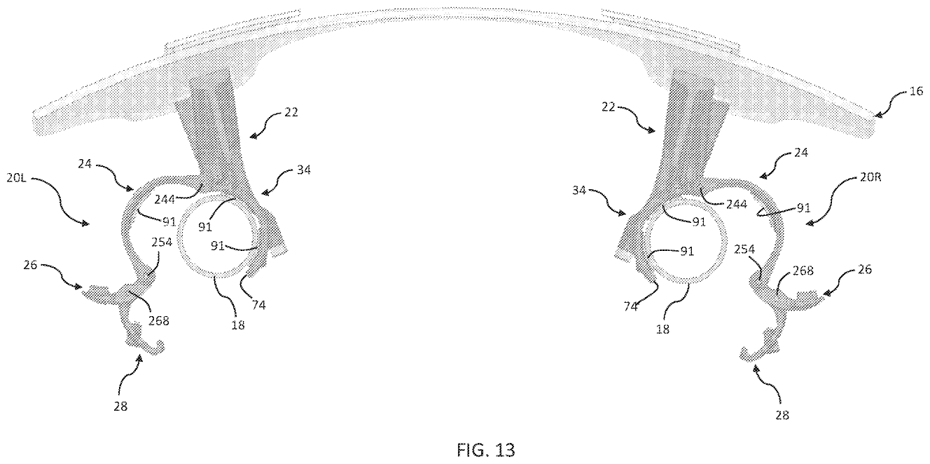

As shown in FIG. 13, after the clamping mechanisms 20L, 20R are pushed toward the fork tubes 18, the curved latches 34 are seated against the fork tubes 18 because the windshield 16 is still slightly flexed, thereby urging the curved latches 34 away from one another and toward the fork tubes 18. As a result, the resilient pads 91 affixed to the curved latches 34 are partially compressed against the fork tubes 18 by the force applied by the windshield 16 attempting to return to its unflex, original state. As the clamping mechanisms 20L, 20R are moved to engage the fork tubes 18 in the manner described above, the clamps 24, levers 26 and hooks 28 remain in substantially the same position (or at least are prevented from freely rotating about the pivot pins 244, 254 and 268) because the O-rings 246, 248, 256, 258, 270 and 272 (described above with reference to FIG. 3) positioned between the mount 22 and the clamp 24, the clamp 24 and the lever 26, and the lever 26 and the hook 28 provide some friction between the moving parts of the clamping mechanisms 20L, 20R.

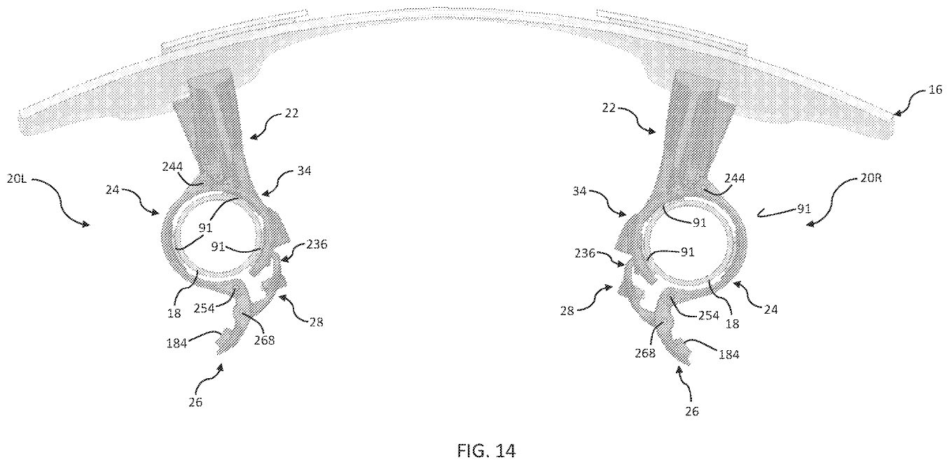

With the clamping mechanisms 20L, 20R positioned as shown in FIG. 13, the clamps 24 may be pivoted about the pivot pins 244 toward the fork tubes 18 such that the resilient pads 91 affixed to the clamps 24 come into contact with the fork tubes 18 as shown in FIG. 14. Additionally, the levers 26 may be pivoted about the pivot pins 254 and the hooks 28 pivoted about the pivot pins 268 such that the curved end walls 236 of the hooks 28 can be positioned within the slots 80 (FIG. 2) of the curved latches 34 of the mounts 22. At this point, the clamping mechanisms 20L, 20R may be moved up or down the fork tubes 18 to a desired height. To fully secure the clamping mechanisms 20L, 20R (and the windshield 16) to the fork tubes 18 once the clamping mechanisms 20L, 20R are in the positions shown in FIG. 14, the levers 26 are pivoted about the pivot pins 254 toward the clamps 24 until the stops 184 of the levers 26 engage the fork tubes 18 as depicted in FIG. 11. This action compresses the resilient pads 91 against the fork tubes 18 to retain the clamping mechanisms 20L, 20R and the windshield 16 securely in place as is described further below.

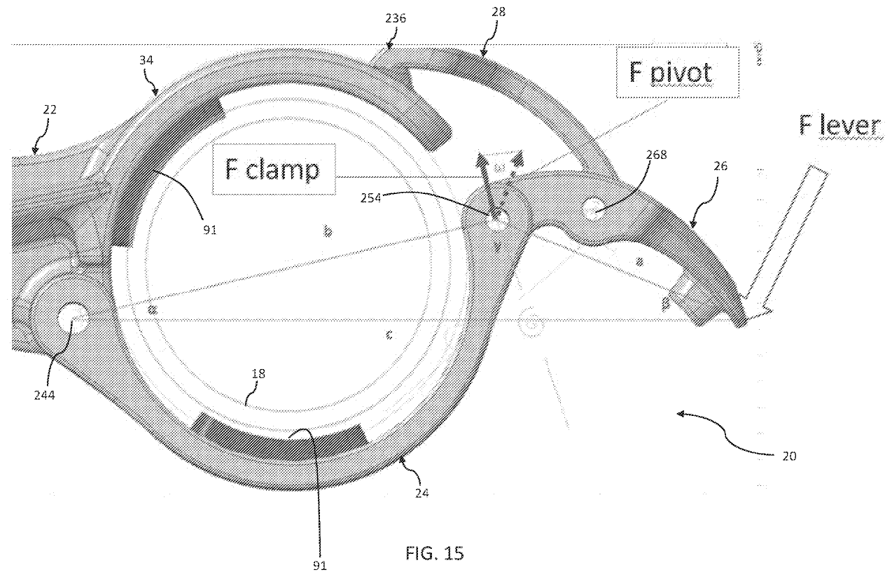

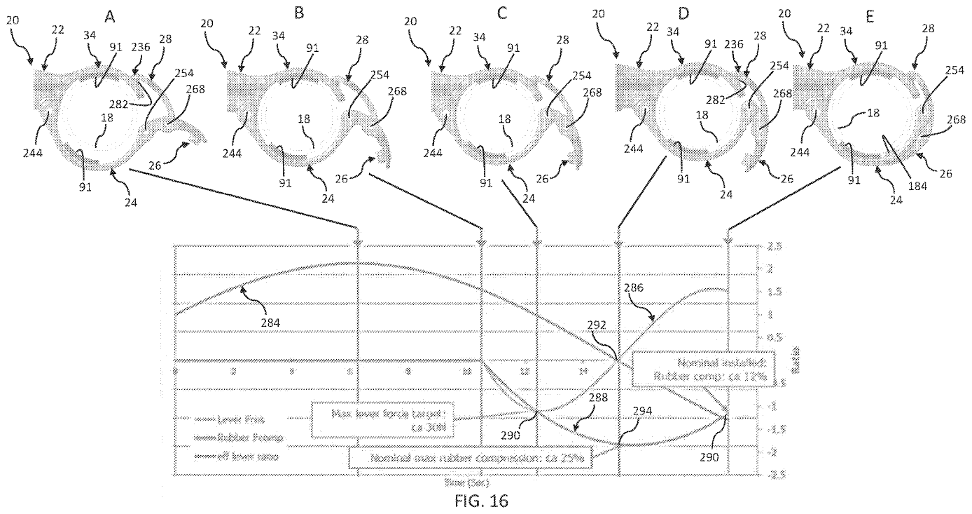

FIG. 15 depicts the forces generated and applied during operation of a clamping mechanism 20 according to embodiments of the disclosure. F pivot is related to the input force, F lever, by a simple lever ratio. F lever is the force applied to the lever 26 to rotate the lever about pivot pin 254 toward the clamp 24. F clamp is the clamping force applied to the fork tube 18 by the clamp 24 via the resilient pads 91. F clamp is related to the pivot force, F pivot, by a trigonometric function dependent upon the angle omega. As shown in the figure, the angle omega is the angle between the tangential trajectory at the pivot pin 244 and the effective lever arm of the lever 26. As the lever 26 is rotated in the clockwise direction about the pivot pin 254 (i.e., as the clamping mechanism 20 is closed), the lever 26 will pass through a position (such as arrangement A of FIG. 16) where the angle omega is zero degrees, and through) cos (0°)=1 the resulting clamp force is equal to the input force, F lever, multiplied by the lever ratio. As the lever 26 is rotated further clockwise, the angle omega becomes 90 degrees (see arrangement D of FIG. 16), and since) cos (90°)=1, any force applied at F lever will result in zero clamping force (i.e., the force is essentially applied rectangular to the evaluated force direction, F clamp).

FIG. 16 depicts the relationships between the forces on the lever 26 and the clamping forces on the fork tube 18 as a clamping mechanism 20 according to embodiments of the disclosure is moved from an engaged state wherein the curved end wall 236 of the hook 28 is positioned within the slot 80 of the curved latch 34 of the mount 22 to a fully clamped state. Arrangement A in FIG. 16 shows the engaged state. In the engaged state depicted, the resilient pad 91 on the clamp 24 is not compressed against (or even contacting) the fork tube 18. As depicted by the lever ratio curve 284, arrangement A corresponds to the maximum effective lever ratio (i.e., a ratio of approximately 2.2). As the lever force curve 286 indicates, at arrangement A there is zero force being applied to lever 26. Similarly, the compression force curve 288 shows that in arrangement A there is zero compression force being applied to the fork tube 18 by the clamping mechanism 20.

In arrangement B of FIG. 16, force is beginning to be applied to the lever 26 to cause the lever 26 to rotate clockwise about the pivot pin 254, which also begins the application of compression force to the fork tube 18 by the clamping mechanism 20 through the resilient pads 91 affixed to the curved latch 34 and the clamp 24. At this point, the resilient pads 91 begin to compress. As the lever 26 is further moved toward the clamp 24 (i.e., further rotated about the pivot pin 254) from the position shown in arrangement B to the position shown in arrangement C, the lever force increases (shown as a decrease in the lever force curve 286) and the compression force applied to the fork tube 18 by the clamping mechanism 20 through the resilient pads 91 increases (shown as a decrease in the compression force curve 288). When the lever 26 is in the position shown in arrangement C, maximum force is being applied to the lever 26 as indicated by the point 290 of the lever force curve 286. The amount of force required to rotate the lever 26 further clockwise about pivot pin 254 decreases from the maximum force to zero when the lever 26 is rotated to the position depicted in arrangement D. At the same time, the compression force on the fork tube 18 increases as the lever 26 is moved from the position of arrangement C to the position of arrangement D as indicated by compression force curve 288.

When the lever 26 is in the position shown in arrangement D, zero force is applied to the lever 26 as shown by the point 292 of the lever force curve 286 because the pivot pin 268, the pivot pin 254 and the contact line between the curved end wall 236 of the hook 28 and the protruding ridge 282 extending along the slot 80 of the curved latch 34 are all aligned. Arrangement D also represents a zero ratio between the applied lever force and the resulting clamping force as indicated by lever ratio curve 284. Arrangement D also represents the maximum compression force applied to the fork tube 18 by the clamping mechanism 20 as represented by the point 294 on the compression force curve 288.

Negative force is required to move the lever 26 from the position shown in arrangement D to the position shown in arrangement E because the pivot pin 268 is located past (i.e., further clockwise relative to) the pivot pin 254 such that a line between the pivot pin 268 and the contact between the curved end wall 236 of the hook 28 and the protruding ridge 282 of the curved latch 34 is to the left of the pivot pin 254 as viewed in the figures. In other words, when the lever 26 just passes (in a clockwise direction) the position shown in arrangement D, the compression force applied to the resilient pads 91 releases partially, moving both the curved latch 34 and the clamp 24 away from the fork tube 18 and drawing the lever 26 inwardly toward the clamp 24. As the resilient pads 91 expand slightly, the lever 26 snaps into the position of arrangement E, and the stop 184 of the lever 26 engages the fork tube 18. The negative force on the lever 26 is shown by the lever force curve 286. Also, the expansion or reduction of compression force on the resilient pads 91 is depicted by the upward slope on the compression force curve 288 between the point 294 and the point 296. Arrangement E thus depicts the fully clamped state of the clamping mechanism 20.

In certain embodiments of the present disclosure, after the clamping mechanisms 20L, 20R are placed in the fully clamped state, one or both of the clamping mechanisms may be locked to the corresponding fork tube 18 using the bolt 278. Referring back to FIG. 11, which shows the clamping mechanism 20L in the fully clamped state, the bolt 278 has been threaded into the threaded opening 86 of the threaded boss 82 disposed on the curved latch 34 of the mount 22. When the bolt 278 is seated within the threaded opening 86, the gap 298 formed between the head 300 of the bolt 278 and the protrusion 242 of the curved end wall 236 of the catch 218 is too small to permit removal of the curved end wall 236 from the slot 80 formed in the curved latch 34 of the mount 22. Even if the lever 26 is rotated counter-clockwise about the pivot pin 254, the hook 28 cannot be decoupled from the mount 22, thereby preventing unauthorized opportunistic removal of the clamping mechanism 20L and the windshield 16 from the fork tube 18.

The process for removing the windshield 16 from the fork tubes 18 is substantially the reverse of the process described above and is therefore not described in detail herein. It should be noted, however, that (as best shown in FIG. 11) the stop 184 of the lever 26 provides a gap 302 between the outer edge 176 of the force body 166 of the lever 26 and the fork tube 18 to permit a driver to place one or more fingertips between the lever 26 and the fork tube 18 to begin the removal process by rotating the lever 26 in a counter-clockwise direction about pivot pin 254 and away from the fork tube 18. If the bolt 278 is used to lock the clamping mechanism 20L to the fork tube 18, then the bolt 278 must be removed before the hook 28 can be decoupled from the curved latch 34 of the mount 22.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1-19. (canceled)

20. A clamping system for removably securing a windshield to fork tubes of a motorcycle, comprising:
a left-hand clamping mechanism configured to clamp to a left-hand fork tube; and
a right-hand clamping mechanism configured to clamp to a right-hand fork tube;
wherein each of the left-hand clamping mechanism and the right-hand clamping mechanism comprises:
a mount including a curved latch having an inner concave surface with a resilient pad, a mount knuckle, and a slot;
a clamp including upper and lower clamping segments, each having an inner concave surface with a resilient pad, an inner knuckle pivotally connected to the mount knuckle by a first pivot pin, and an outer knuckle;
a lever including upper and lower arms, each having a fulcrum knuckle pivotally connected to the outer knuckles of the clamp by a second pivot pin, and a follower knuckle positioned between the fulcrum knuckle and an outer edge of the lever; and
a hook including a hook knuckle pivotally connected to the follower knuckles of the lever by a third pivot pin, and a catch having a curved end wall;
wherein the mount of the left-hand clamping mechanism includes a pair of arms extending from the curved latch, each arm including a mating surface configured to engage a left-hand side of the windshield and a threaded boss configured to receive a bolt to attach the arms to the left-hand side of the windshield;
wherein the mount of the right-hand clamping mechanism includes a pair of arms extending from the curved latch, each arm including a mating surface configured to engage a right-hand side of the windshield and a threaded boss configured to receive a bolt to attach the arms to the right-hand side of the windshield;
wherein each of the left-hand clamping mechanism and the right-hand clamping mechanism is movable to an engaged state around the corresponding fork tube by rotating the clamp, the lever and the hook relative to one another about the first, second and third pivot pins and engaging the curved end wall of the hook with the slot of the curved latch; and
wherein each of the left-hand clamping mechanism and the right-hand clamping mechanism is movable from the engaged state to a fully clamped state secured to the corresponding fork tube by rotating the outer edge of the lever about the second pivot pin toward the clamp, thereby drawing the third pivot pin and the hook knuckle toward the clamp and compressing the resilient pads of the curved latch and the clamp against the corresponding fork tube.

21. The clamping system of claim 20, wherein the curved latch of each of the left-hand clamping mechanism and the right-hand clamping mechanism further includes an outer convex surface with a protruding ridge that extends along the slot, the protruding ridge being configured to mate with an inner concave surface of the curved end wall of the catch when the clamping mechanisms are in the fully clamped state.

22. The clamping system of claim 21, wherein the curved latch of each of the left-hand clamping mechanism and the right-hand clamping mechanism further includes a threaded boss disposed on the outer convex surface adjacent the slot, the threaded boss being configured to receive a bolt that prevents removal of the curved end wall of the hook from the slot of the curved latch.

23. The clamping system of claim 20, wherein the upper and lower clamping segments of the clamp of each of the left-hand clamping mechanism and the right-hand clamping mechanism are connected to one another by a connecting portion having an outer edge that, together with the upper and lower clamping segments forms a first cutout that receives the lever when the clamping mechanisms are in the fully clamped state.

24. The clamping system of claim 23, wherein the connecting portion of each of the left-hand clamping mechanism and the right-hand clamping mechanism further includes an inner edge that, together with inner knuckles of the upper and lower clamping segments forms a second cutout that receives the mount knuckle of the clamping mechanism.

25. The clamping system of claim 20, wherein the lever of each of the left-hand clamping mechanism and the right-hand clamping mechanism includes a force body including the outer edge, and a stop formed on an inner surface of the force body, the upper and lower arms of the lever extending from force body.

26. The clamping system of claim 20, wherein the first pivot pin of each of the left-hand clamping mechanism and the right-hand clamping mechanism extends through cylindrical bores formed through the inner knuckles of the clamp and the mount knuckle, the second pivot pin of each of the left-hand clamping mechanism and the right-hand clamping mechanism extends through cylindrical bores formed through the outer knuckles of the clamp and the fulcrum knuckles of the lever, and the third pivot pin of each of the left-hand clamping mechanism and the right-hand clamping mechanism extends through cylindrical bores formed through the follower knuckles of the lever and the hook knuckle.

27. The clamping system of claim 26, wherein the first pivot pin of each of the left-hand clamping mechanism and the right-hand clamping mechanism extends through a first O-ring positioned between the inner knuckle of the upper clamping segment of the clamp and the fulcrum knuckle of the upper arm of the lever, and a second O-ring positioned between the fulcrum knuckle of the lower arm of the lever and the inner knuckle of the lower clamping segment of the clamp.

28. The clamping system of claim 26, wherein the second pivot pin of each of the left-hand clamping mechanism and the right-hand clamping mechanism extends through a first O-ring positioned between the outer knuckle of the upper clamping segment of the clamp and the follower knuckle of the upper arm of the lever, and a second O-ring positioned between the follower knuckle of the lower arm of the lever and the outer knuckle of the lower clamping segment of the clamp.

29. The clamping system of claim 26, wherein the third pivot pin of each of the left-hand clamping mechanism and the right-hand clamping mechanism extends through a first O-ring positioned between the follower knuckle of the upper arm of the lever and the hook knuckle, and a second O-ring positioned between the hook knuckle and the follower knuckle of the lower arm of the lever.

30. The clamping system of claim 20, wherein the left-hand clamping mechanism is a mirror image of the right-hand clamping mechanism.

31. The clamping system of claim 20, wherein the left-hand clamping mechanism is moved from the engaged state to the fully clamped state by rotating the outer edge of the lever about the second pivot pin in a clockwise direction and the right-hand clamping mechanism is moved from the engaged state to the fully clamped state by rotating the outer edge of the lever about the second pin in a counter-clockwise direction.

32. The clamping system of claim 20, wherein when the clamping mechanisms are attached to the windshield, a distance between the outer edge of the lever of the left-hand clamping mechanism and the outer edge of the lever of the right-hand clamping mechanism is greater than a smallest distance between the fork tubes.

33. The clamping system of claim 32, wherein as the left-hand clamping mechanism and the right-hand clamping mechanism are pushed onto the left-hand fork tube and the right-hand fork tube, respectively, the windshield flexes to permit the outer edges of the levers of the clamping mechanisms to move toward one another.

34. A method of securing a removable windshield to fork tubes of a motorcycle, comprising:
attaching a left-hand clamping mechanism to a left-hand side of the windshield;
attaching a right-hand clamping mechanism to a right-hand side of the windshield;
pushing the left-hand clamping mechanism onto a left fork tube such that a resilient pad affixed to a curved latch of the left-hand clamping mechanism engages one side of the left fork tube;
pushing the right-hand clamping mechanism onto a right fork tube such that a resilient pad affixed to a curved latch of the right-hand clamping mechanism engages one side of the right fork tube that faces the one side of the left-fork tube;
rotating a clamp, a lever and a hook of the left-hand clamping mechanism counter-clockwise around the left fork tube to engage a curved end wall of the hook with a slot formed through the curved latch of the left-hand clamping mechanism;
rotating a clamp, a lever and a hook of the right-hand clamping mechanism clockwise around the right fork tube to engage a curved end wall of the hook with a slot formed through the curved latch of the right-hand clamping mechanism;
rotating the lever of the left-hand clamping mechanism clockwise about a pivot pin toward the clamp, thereby drawing an end of the hook toward the clamp and compressing the resilient pad of the curved latch and a resilient pad affixed to the clamp against the left fork tube; and
rotating the lever of the right-hand clamping mechanism counter-clockwise about a pivot pin toward the clamp, thereby drawing an end of the hook toward the clamp and compressing the resilient pad of the curved latch and a resilient pad affixed to the clamp against the right fork tube.
